(19) United States
(12) Patent Application Publication
(10) Pub. No.: US 2021/0271554 A1
(43) Pub. Date: Sep. 2, 2021

(54) METHOD AND SYSTEM FOR A CLOUD BACKUP SERVICE LEVERAGING PEER-TO-PEER DATA RECOVERY

(71) Applicant: EMC IP Holding Company LLC, Hopkinton, MA (US)

(72) Inventors: Yossef Saad, Gannei Tikva (IL); Alex Solan, Hertzelia (IL)

(21) Appl. No.: 16/802,709

(22) Filed: Feb. 27, 2020

(51) Int. Cl. G06F 11/14; G06F 16/17

(52) U.S. Cl. CPC G06F 11/1435; G06F 2201/84; G06F 16/1734

(57) ABSTRACT

A method and system for a cloud backup service leveraging peer-to-peer data recovery. Specifically, the disclosed method and system entail the implementation of a backup-as-a-service (BaaS) that, at least in part, extends the recovery of data through peer-to-peer communications. In an enterprise organization, users often share data files and, accordingly, maintain local copies of these data files on their respective computing devices. Recovery of data, through peer-to-peer communications, may involve the retrieval of these maintained local copies.

### BACKGROUND

Within an enterprise organization, users often share a plethora of data files and, accordingly, maintain local copies of these data files on their respective computing devices.

### SUMMARY

In general, in one aspect, the invention relates to a method for data file recovery. The method includes receiving, from a client device, a recovery request including a first file fingerprint for a first data file, identifying a first storage tier and a first file size using the first file fingerprint, making a first determination, based on the first storage tier and the first file size, that the first data file fails to satisfy file transfer criteria, obtaining, based on the first determination, a user list including a first peer user identifier (ID), wherein the user list is associated with the first data file, identifying first peer client device metadata using the first peer user ID, and transmitting, in response to the recovery request, the first peer client device metadata to the client device.

In general, in one aspect, the invention relates to a method for data file recovery. The method includes detecting a trigger event for a recovery operation targeting a first data file, identifying a first file fingerprint for the first data file, issuing, to a backup storage service, a recovery request including the first file fingerprint, and receiving, in response to the recovery request, first peer client device metadata from the backup storage service.

In general, in one aspect, the invention relates to a system. The system includes a plurality of client devices, and a backup storage service operatively connected to the plurality of client devices, and including a computer processor programmed to receive, from a first client device of the plurality of client devices, a recovery request including a file fingerprint for a data file, identify a storage tier and a file size using the file fingerprint, make a determination, based on the storage tier and the file size, that the data file fails to satisfy file transfer criteria, obtain, based on the determination, a user list including a peer user identifier (ID), wherein the user list is associated with the data file, identify, using the peer user ID, peer client device metadata for a second client device of the plurality of client devices, and transmit, in response to the recovery request, the peer client device metadata to the first client device.

Other aspects of the invention will be apparent from the following description and the appended claims.

### BRIEF DESCRIPTION OF DRAWINGS

FIG. 1A shows a system in accordance with one or more embodiments of the invention.

FIG. 1B shows a client device in accordance with one or more embodiments of the invention.

FIG. 1C shows a backup storage service in accordance with one or more embodiments of the invention.

FIGS. 2A and 2B show flowcharts describing a method for backing-up data files in accordance with one or more embodiments of the invention.

FIGS. 3A and 3B show flowcharts describing a method for recovering data files in accordance with one or more embodiments of the invention.

FIGS. 4A and 4B show flowcharts describing a method for recovering data files in accordance with one or more embodiments of the invention.

FIG. 5 shows an exemplary computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

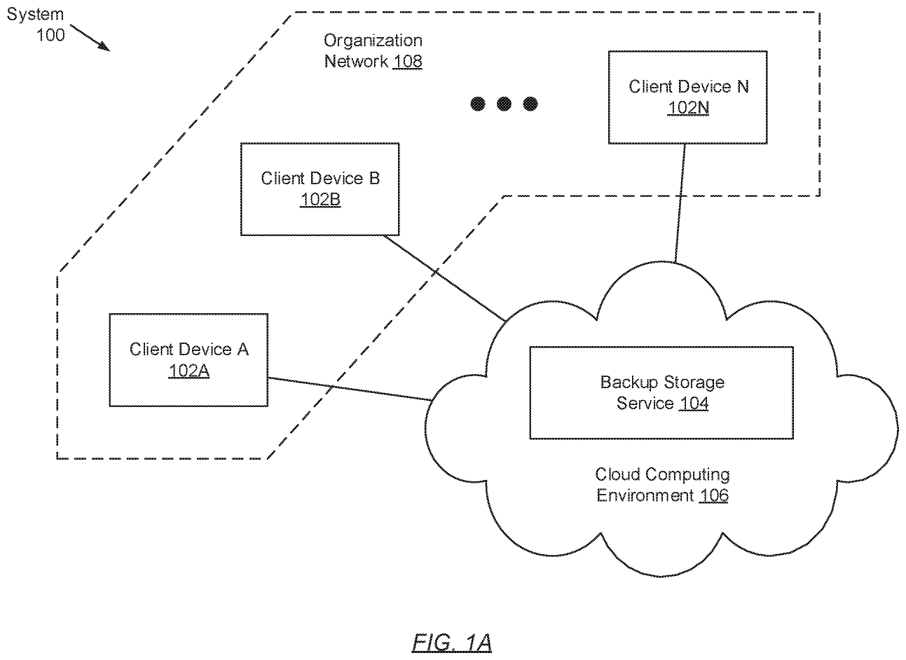

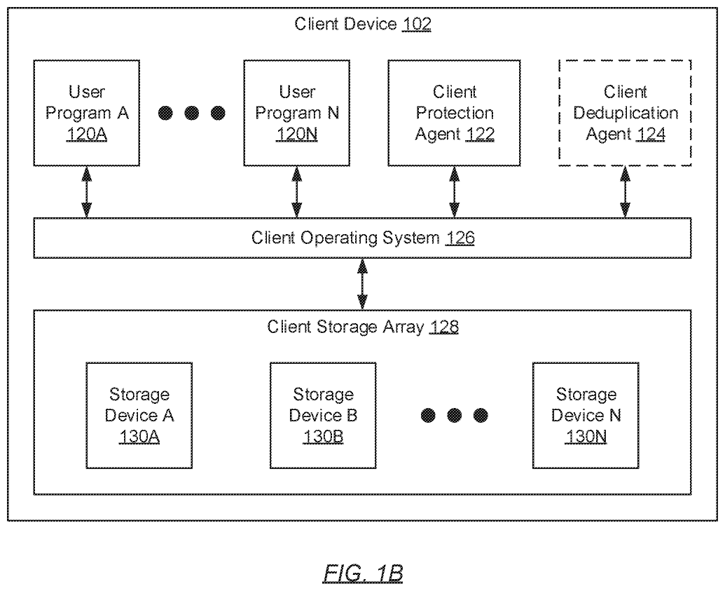

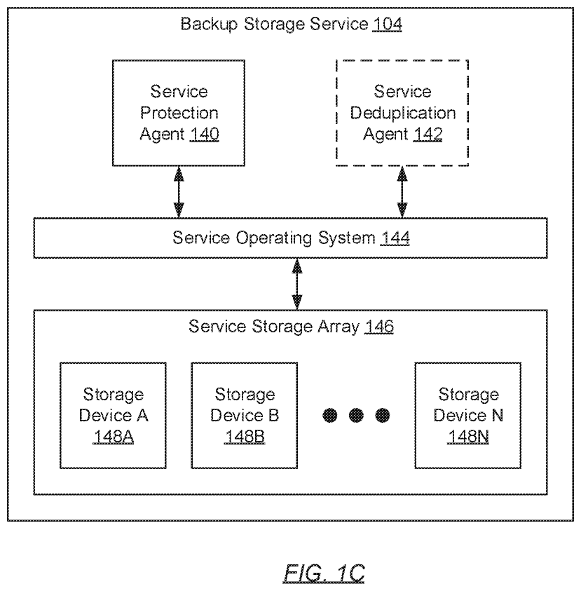

In the following description of FIGS. 1A-5, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for a cloud backup service leveraging peer-to-peer data recovery. Specifically, one or more embodiments of the invention entails the implementation of a backup-as-a-service (BaaS) that, at least in part, extends the recovery of data through peer-to-peer communications. In an enterprise organization, users often share data files and, accordingly, maintain local copies of these data files on their respective computing devices. Recovery of data, through peer-to-peer communications, may involve the retrieval of these maintained local copies.

FIG. 1A shows a system in accordance with one or more embodiments of the invention. The system (100) may include two or more client devices (102A-102N) operatively connected to a backup storage service (104). Each of these system (100) components is described below.

In one embodiment of the invention, the above-mentioned system (100) components may operatively connect to one another through a network (not shown) (e.g., a local area network (LAN), a wide area network (WAN) such as the Internet, a mobile network, etc.). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components. Moreover, the above-mentioned system (100) components may communicate with one another using any combination of wired and/or wireless communication protocols.

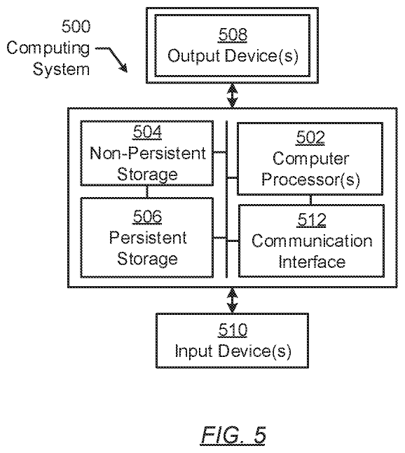

In one embodiment of the invention, a client device (102A-102N) may represent any physical appliance or computing system designed and configured to receive, generate, process, store, and/or transmit digital data, as well as to provide an environment in which one or more computer programs may execute thereon. A client device (102A-102N) may form part of an organization network (108) for a given organization or entity and, accordingly, may operatively connect with one or more other client devices (102A-102N). The aforementioned computer programs may, for example, implement large-scale and complex data processing; or implement one or more services offered locally or over the network. Further, in providing an execution environment for any computer programs installed thereon, a client device (102A-102N) may include and allocate various resources (e.g., computer processors, memory, storage, virtualization, network bandwidth, etc.), as needed, to the computer programs and the tasks (or processes) instantiated thereby. One of ordinary skill will appreciate that a client device (102A-102N) may perform other functionalities without departing from the scope of the invention. Examples of a client device (102A-102N) may include, but are not limited to, a desktop computer, a laptop computer, a server, a mainframe, or any other computing system similar to the exemplary computing system shown in FIG. 5. Moreover, client devices (102A-102N) are described in further detail below with respect to FIG. 1B.

In one embodiment of the invention, the backup storage service (104) may represent a data backup, archiving, and/or disaster recovery storage system. The backup storage system (104) may be implemented using one or more servers (not shown). Each server may refer to a physical or virtual server, which may reside in a cloud computing environment (106). Accordingly, the backup storage service (104) may operate as a backup-as-a-service (BaaS) cloud computing service model. Additionally or alternatively, the backup storage service (104) may be implemented using one or more computing systems similar to the exemplary computing system shown in FIG. 5. Furthermore, the backup storage service (104) is described in further detail below with respect to FIG. 1C.

While FIG. 1A shows a configuration of components, other system (100) configurations may be used without departing from the scope of the invention.

FIG. 1B shows a client device in accordance with one or more embodiments of the invention. The client device (102) may include one or more user programs (120A-120N), a client protection agent (122), a client deduplication agent (124) (optionally), a client operating system (126), and a client storage array (128). Each of these client device (102) subcomponents is described below.

In one embodiment of the invention, a user program (120A-120N) may refer to a computer program that may execute on the underlying hardware of the client device (102). Specifically, a user program (120A-120N) may be designed and configured to perform one or more functions, tasks, and/or activities instantiated by a user of the client device (102). Accordingly, towards performing these operations, a user program (120A-120N) may include functionality to request and consume client device (102) resources (e.g., computer processors, memory, storage, virtualization, network bandwidth, etc.) by way of service calls to the client operating system (126). One of ordinary skill will appreciate that a user program (120A-120N) may perform other functionalities without departing from the scope of the invention. Examples of a user program (120A-120N) may include, but are not limited to, a word processor, an email client, a database client, a web browser, a media player, a file viewer, an image editor, a simulator, a computer game, or any other computer executable application.

In one embodiment of the invention, the client protection agent (122) may refer to a computer program that may execute on the underlying hardware of the client device (102). Specifically, the client protection agent (122) may be designed and configured to perform client-side data backup and recovery operations. To that extent, the client protection agent (122) may protect one or more data files (or objects) on the client device (102) against data loss (i.e., backup the data file(s)); and reconstruct one or more data files on the client device (102) following such data loss (i.e., recover the data file(s)). One of ordinary skill will appreciate that the client protection agent (122) may perform other functionalities without departing from the scope of the invention.

In one embodiment of the invention, the client deduplication agent (124) may refer to a computer program that may execute on the underlying hardware of the client device (102). Specifically, the client deduplication agent (124) may be designed and configured to perform client- or source-side data deduplication. Source-side data deduplication may refer to the identification and subsequent elimination of redundant data prior to transmission of the data to the backup storage service (104). To that extent, the client deduplication agent (124) may include functionality to: obtain data selected for backup from and by the client protection agent (122); apply data deduplication on the obtained data to render deduplicated data; and provide the deduplicated data back to the client protection agent (122), whom may subsequently transmit the deduplicated data to the backup storage service (104). One of ordinary skill will appreciate that the client deduplication agent (124) may perform other functionalities without departing from the scope of the invention.

In one embodiment of the invention, the client operating system (126) may refer to a computer program that may execute on the underlying hardware of the client device (102). Specifically, the client operating system (126) may be designed and configured to oversee client device (102) operations. To that extent, the client operating system (126) may include functionality to, for example, support fundamental client device (102) functions; schedule tasks; mediate interactivity between logical (e.g., software) and physical (e.g., hardware) client device (102) components; allocate client device (102) resources; and execute or invoke other computer programs executing on the client device (102). One of ordinary skill will appreciate that the client operating system (126) may perform other functionalities without departing from the scope of the invention.

In one embodiment of the invention, the client storage array (128) may refer to a collection of one or more physical storage devices (130A-130N) on which various forms of digital data—e.g., one or more data files—may be consolidated. Each physical storage device (130A-130N) may encompass non-transitory computer readable storage media on which data may be stored in whole or in part, and temporarily or permanently. Further, each physical storage device (130A-130N) may be designed and configured based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the client storage array (128) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, a data file may refer to a data object or container for storing data. Data may encompass computer readable content (e.g., images, text, video, audio, machine code, any other form of computer readable content, or a combination thereof), which may be generated, interpreted, and/or processed by any given user program (120A-120N). Further, a data file may store data in (a) undeduplicated form or (b) deduplicated form. In brief, the latter form of data may be produced through the application of data deduplication on the former form of the data. That is, undeduplicated data may entail computer readable content that may or may not include redundant information. In contrast, deduplicated data may result from the elimination of any redundant information found throughout the undeduplicated computer readable content and, accordingly, may instead reflect a file recipe of the undeduplicated computer readable content. A file recipe may refer to a sequence of chunk identifiers (or pointers) (also referred to as chunk fingerprints) associated with (or directed to) unique data chunks consolidated in physical storage. Collectively, the sequence of chunk fingerprints—representative of the deduplicated data—may be used to reconstruct the corresponding undeduplicated data. Moreover, a given chunk fingerprint for a given data chunk may encompass a cryptographic hash of the given data chunk.

While FIG. 1B shows a configuration of components, other client device (102) configurations may be used without departing from the scope of the invention.

FIG. 1C shows a backup storage service in accordance with one or more embodiments of the invention. The backup storage service (104) may include a service protection agent (140), a service deduplication agent (142) (optionally), a service operating system (144), and a service storage array (146). Each of these backup storage service (104) subcomponents is described below.

In one embodiment of the invention, the service protection agent (140) may refer to a computer program that may execute on the underlying hardware of the backup storage service (104). Specifically, the backup protection agent (148) may be designed and configured to perform server-side data backup and recovery operations. To that extent, the service protection agent (140) may receive data (or data files), submitted by the client device(s) (102A-102N), to store on the service storage array (146) during data backup operations; and, conversely, may retrieve backup data (or data files) from the service storage array (146) during data recovery operations. One of ordinary skill will appreciate that the service protection agent (140) may perform other functionalities without departing from the scope of the invention.

In one embodiment of the invention, the service deduplication agent (142) may refer to a computer program that may execute on the underlying hardware of the backup storage service (104). Specifically, should any client device (102A-102N) not include a client deduplication agent (124), the service deduplication agent (142) may be designed and configured to perform service-side data deduplication. Service-side data deduplication may refer to the identification and subsequent elimination of redundant data after the transmission of the data to the backup storage service (104). To that extent, the service deduplication agent (142) may include functionality to: obtain data from the service protection agent (140); apply data deduplication on the obtained data to render deduplicated data; and provide the deduplicated data back to the service protection agent (140), whom may subsequently store the deduplicated data on the service storage array (146). One of ordinary skill will appreciate that the service deduplication agent (142) may perform other functionalities without departing from the scope of the invention.

In one embodiment of the invention, the service operating system (144) may refer to a computer program that may execute on the underlying hardware of the backup storage service (104). Specifically, the service operating system (144) may be designed and configured to oversee backup storage service (104) operations. To that extent, the service operating system (144) may include functionality to, for example, support fundamental backup storage service (104) functions; schedule tasks; mediate interactivity between logical (e.g., software) and physical (e.g., hardware) backup storage service (104) components; allocate backup storage service (104) resources; and execute or invoke other computer programs executing on the backup storage service (104). One of ordinary skill will appreciate that the service operating system (144) may perform other functionalities without departing from the scope of the invention.

In one embodiment of the invention, the service storage array (146) may refer to a collection of one or more physical storage devices (148A-148N) on which various forms of digital data may be consolidated. Each physical storage device (148A-148N) may encompass non-transitory computer readable storage media on which data may be stored in whole or in part, and temporarily or permanently. Further, each physical storage device (148A-148N) may be designed and configured based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the service storage array (146) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

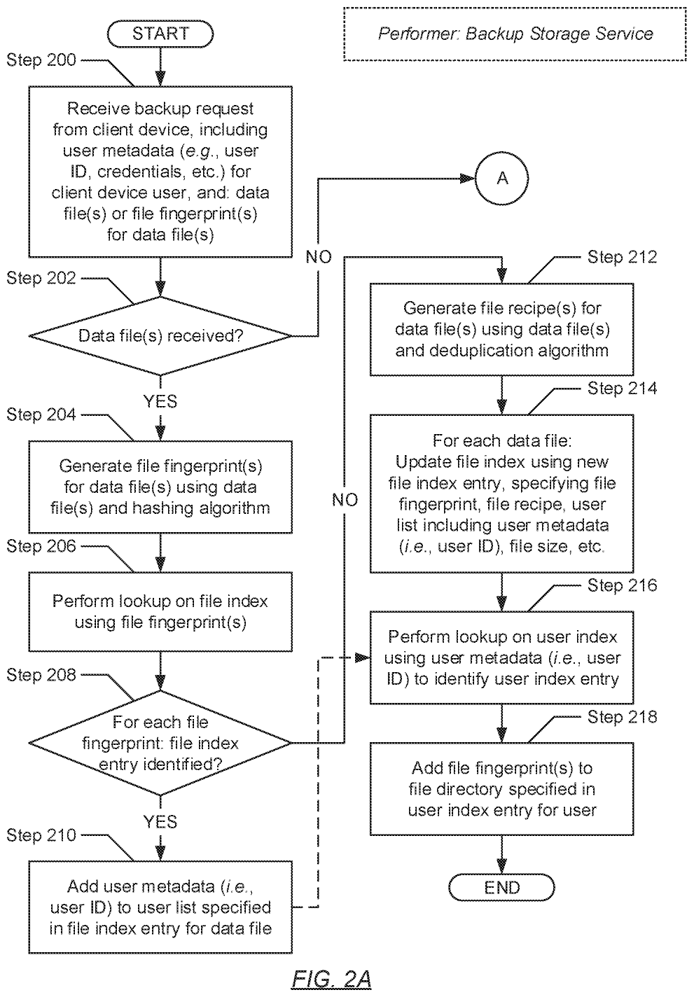

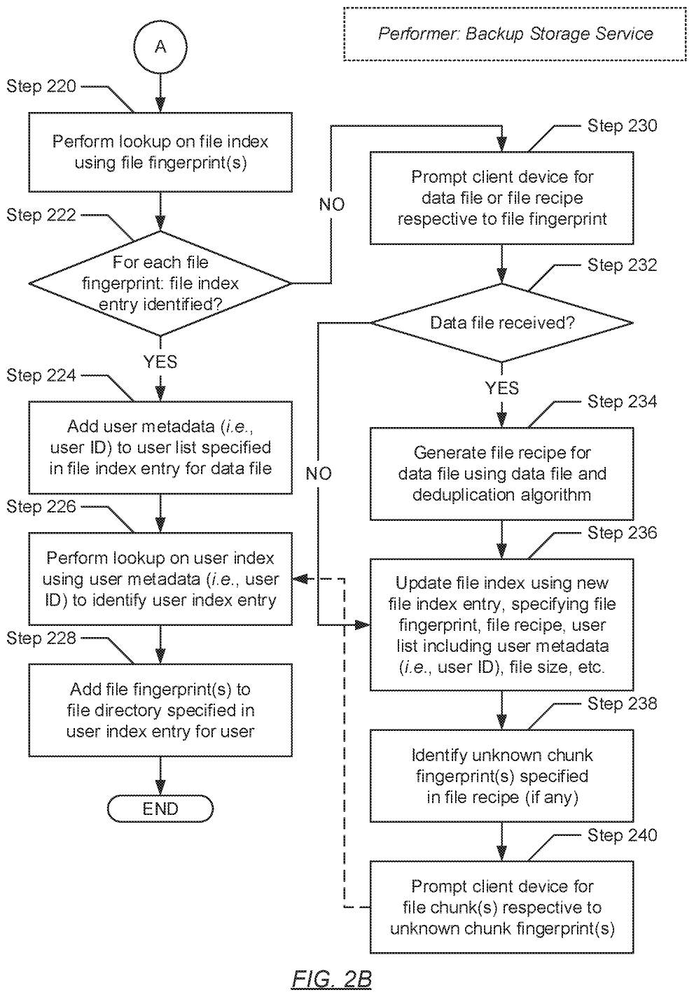

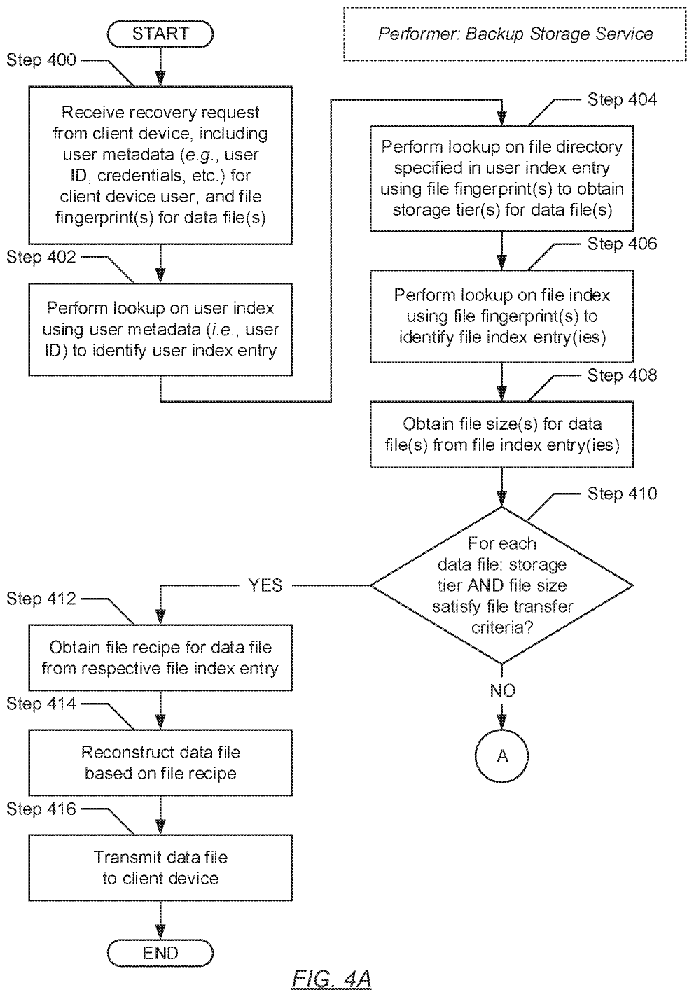

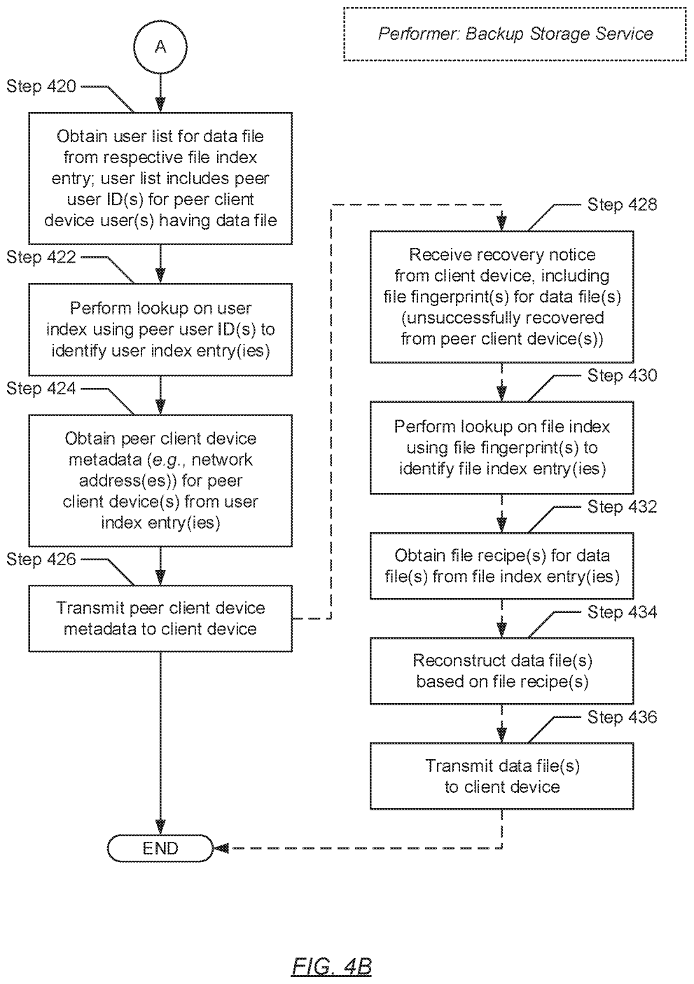

In one embodiment of the invention, at least a portion of the service storage array (146) may be used to maintain a file index, a user index, and a chunk index (all not shown) (described below) (see e.g., FIGS. 2A, 2B, 4A, and 4B).

While FIG. 1C shows a configuration of components, other backup storage system (106) configurations may be used without departing from the scope of the invention.

FIGS. 2A and 2B show flowcharts describing a method for backing-up data files in accordance with one or more embodiments of the invention. The various steps outlined below may be performed by the backup storage service (see e.g., FIGS. 1A and 1C). Further, while the various steps in the flowchart are presented and described sequentially, one of ordinary skill will appreciate that some or all steps may be executed in different orders, may be combined or omitted, and some or all steps may be executed in parallel.

Turning to FIG. 2A, in Step 200, a backup request is received from a client device (see e.g., FIG. 1A). In one embodiment of the invention, the backup request may include user metadata associated with a client device user of the client device. The user metadata may include, but is not limited to, a unique user identifier (ID) assigned to the client device user, and authentication credentials (e.g., a password, a passphrase, a pin number, biometric data, etc.) linked to the user ID and, subsequently, the client device user. The authentication credentials may or may not be required for authorizing writing and/or reading access to one or more data files belonging to the client device user, which may be maintained on the backup storage service. Further, the backup request may additionally include one or more data files (to-be-stored) or one or more file fingerprints (described above) (see e.g., FIG. 1C) representative of the data file(s).

In Step 202, a determination is made as to whether one or more data files had been received (in Step 200) versus one or more file fingerprints. In one embodiment of the invention, if it is determined that the data file(s) had been received, then the process proceeds to Step 204. On the other hand, in another embodiment of the invention, if it is alternatively determined that the file fingerprint(s) had been received, then the process alternatively proceeds to Step 220 (see e.g., FIG. 2B).

In Step 204, upon determining (in Step 202) that one or more data files had been received (along with the backup request in Step 200), a file fingerprint is generated for each received data file. In one embodiment of the invention, each file fingerprint may be generated through the application of a hashing algorithm onto the respective data file. The hashing algorithm may refer to any existing cryptographic hashing algorithm such as, for example, the Secure Hash Algorithm 1 (SHA-1) or the Message Digest 5 (MD5) algorithm.

In Step 206, a lookup is performed on a file index using the file fingerprint(s) (generated in Step 204). In one embodiment of the invention, the file index may represent a data structure (e.g., a data table), stored on the service storage array, for maintaining various information pertaining to one or more data files. Information relating to each data file may be indexed by way of a file index entry, which may store at least the following information respective to a given data file: (a) a file fingerprint (or hash) used to uniquely identify the content contained in the given data file; (b) a file recipe representative of a sequence of chunk fingerprints associated with (or directed to) unique data chunks identified throughout the undeduplicated data of the given data file; (c) a user list including one or more user IDs for one or more client device users, where the client device user(s) each maintain a local copy of the given data file on their respective client device(s); and (d) data file metadata describing the given data file such as, for example, a file size (in bytes) reflecting the storage size of the given data file. Each file index entry may specify additional or alternative information pertinent to a given data file without departing from the scope of the invention.

In Step 208, a determination is made, for each received data file, as to whether a file index entry exists (or has been identified) for the data file based on the lookup (performed in Step 206). A file index entry may be identified as pertaining to the data file should the file fingerprint (generated in Step 204) for the data file match a stored file fingerprint in one of the file index entries of the file index. Conversely, the file index may not maintain a file index entry for a data file should the file fingerprint (generated in Step 204) for the data file mismatch all stored file fingerprints in all existing file index entries of the file index. Accordingly, in one embodiment of the invention, for a given data file, if it is determined that a file index entry has been identified for the given data file, then the process proceeds to Step 210. On the other hand, in another embodiment of the invention, for a given data file, if it is alternatively determined that none of the file index entries pertain to the given data file, then the process alternatively proceeds to Step 212.

In Step 210, upon determining (in Step 208) that the file index maintains an existing file index entry for a given data file, the identified file index entry is updated using the user ID (received alongside the backup request in Step 200). Specifically, in one embodiment of the invention, the aforementioned user ID may be added to the existing one or more user IDs included in the user list (described above) specified in the identified file index entry. By adding the user ID into the user list, the service tracks that the associated client device user maintains a local copy of the data file on their respective client device. Thereafter, the process proceeds to Step 216 (described below).

In Step 212, upon alternatively determining (in Step 208) that the file index does not maintain an existing file index entry for a given data file, a file recipe for the given data file is generated. In one embodiment of the invention, the file recipe (described above) may be generated through the application of any existing deduplication algorithm onto the given data file.

In Step 214, the file index is updated using a new file index entry for each data file (received in Step 200) to which an existing file index entry had not been linked. Specifically, in one embodiment of the invention, a given new file index entry, for a given data file, may be generated to specify at least the following information: (a) the file fingerprint (generated in Step 204) for the given data file; (b) the file recipe (generated in Step 212) for the given data file; (c) a user list initialized with the user ID (received in Step 200) of the client device user; and (d) data file metadata (e.g., a file size) describing the given data file.

In Step 216, a lookup is performed on a user index using the user ID (i.e., user metadata) (received in Step 200) to identify an existing user index entry mapped to the client device user. In one embodiment of the invention, the user index may represent a data structure (e.g., a data table), stored on the service storage array, for maintaining various information pertaining to one or more client device users. Information relating to each client device user may be indexed by way of a user index entry, which may store at least the following information respective to a given client device user: (a) a user ID uniquely identifying the given client device user; (b) authentication credentials (e.g., a password, a passphrase, a pin number, biometric data, etc.) linked to the user ID; (c) a file directory maintaining the file fingerprint for each data file pertaining to the given client device user, alongside the storage tier (described below) with which the data file may be associated; and (d) client device metadata describing the client device being operated by the given client device user. The client device metadata may include, but is not limited to, a device name assigned to the client device, a network address (e.g., an Internet Protocol (IP) address) assigned to the client device, a port number of the client device through which data file requests may be made, etc. Each user index entry may specify additional or alternative information pertinent to a given client device user without departing from the scope of the invention.

In Step 218, following the identification of a user index entry (in Step 216), the file fingerprint(s) (generated in Step 204) is/are used to update the user index entry. Specifically, in one embodiment of the invention, the file fingerprint(s) may be added to the file directory (described above) specified in the identified user index entry. Prior to or following the addition of the file fingerprint(s), the client device user may be prompted to designate storage tier(s) (described above) with which the data file(s), identified by the file fingerprint(s), may be associated and stored.

Turning to FIG. 2B, in Step 220, upon alternatively determining (in Step 202) that one or more file fingerprints had been received (along with the backup request in Step 200), a lookup is performed on the file index (described above) using the received file fingerprint(s). Thereafter, in Step 222, a determination is made, for each received file fingerprint, as to whether a file index entry exists (or has been identified) for a data file, mapped to the file fingerprint, based on the lookup (performed in Step 220). A file index entry may be identified as pertaining to the data file should the file fingerprint (received in Step 200) for the data file match a stored file fingerprint in one of the file index entries of the file index. Conversely, the file index may not maintain a file index entry for a data file should the file fingerprint (received in Step 200) for the data file mismatch all stored file fingerprints in all existing file index entries of the file index. Accordingly, in one embodiment of the invention, for a given file fingerprint, if it is determined that a file index entry has been identified as being associated with the given file fingerprint, then the process proceeds to Step 224. On the other hand, in another embodiment of the invention, for a given file fingerprint, if it is alternatively determined that none of the file index entries have been identified as being associated with the given file fingerprint, then the process alternatively proceeds to Step 230.

In Step 224, upon determining (in Step 222) that the file index maintains an existing file index entry as being associated with a given file fingerprint, the identified file index entry is updated using the user ID (received alongside the backup request in Step 200). Specifically, in one embodiment of the invention, the aforementioned user ID may be added to the existing one or more user IDs included in the user list (described above) specified in the identified file index entry. By adding the user ID into the user list, the service tracks that the associated client device user maintains a local copy of the data file on their respective client device.

In Step 226, a lookup is performed on a user index (described above) using the user ID (i.e., user metadata) (received in Step 200) to identify an existing user index entry mapped to the client device user. Thereafter, in Step 228, the file fingerprint(s) (received in Step 200) is/are used to update the user index entry (identified in Step 226). Specifically, in one embodiment of the invention, the file fingerprint(s) may be added to the file directory (described above) specified in the identified user index entry. Prior to or following the addition of the file fingerprint(s), the client device user may be prompted to designate storage tier(s) (described above) with which the data file(s), identified by the file fingerprint(s), may be associated and stored.

In Step 230, upon alternatively determining (in Step 222) that the file index does not maintain an existing file index entry as being associated with a given file fingerprint, the client device is prompted for the data file or the file recipe respective to the given file fingerprint. In one embodiment of the invention, in response to the prompt, the client device may transmit a data file if the client device does not have the capability to perform client-side data deduplication (i.e., does not have a client deduplication agent executing thereon) (see e.g., FIG. 1B). In another embodiment of the invention, in response to the prompt, the client device may alternatively transmit a file recipe (described above) if the client device includes the functionality to perform client-side data deduplication (or supports a client deduplication agent executing thereon).

In Step 232, a determination is made as to whether a data file, respective to a given file fingerprint, had been received (in response to the prompt issued in Step 230). In one embodiment of the invention, if it is determined that a data file (versus a file recipe) has been received, then the process proceeds to Step 234. On the other hand, in another embodiment of the invention, if it is alternatively determined that a file recipe (versus a data file) has been received, then the process alternatively proceeds to Step 236.

In Step 234, upon determining (in Step 232) that a data file, respective to a given file fingerprint (received in Step 200), had been received (in response to the prompt issued in Step 230), a file recipe for the given data file is generated. In one embodiment of the invention, the file recipe (described above) may be generated through the application of any existing deduplication algorithm onto the given data file.

In Step 236, the file index is updated using a new file index entry for each data file (received in Step 200) to which an existing file index entry had not been linked. Specifically, in one embodiment of the invention, a given new file index entry, for a given data file, may be generated to specify at least the following information: (a) the file fingerprint (received in Step 200) for the given data file; (b) the file recipe (received in Step 230 or generated in Step 234) for the given data file; (c) a user list initialized with the user ID (received in Step 200) of the client device user; and (d) data file metadata (e.g., a file size) describing the given data file.

In Step 238, zero or more unknown chunk fingerprints specified in the file recipe (received in Step 230 or generated in Step 234), for a given data file, is/are identified. In one embodiment of the invention, an unknown chunk fingerprint may reference a new data file chunk that may not already be stored on the service storage array of the backup storage service (see e.g., FIG. 1C). Accordingly, if at least one unknown chunk fingerprint is identified, in Step 240, the client device is prompted to provide the at least one data file chunk respective to the unknown chunk fingerprint(s) (identified in Step 238). Any received data file chunk(s) may subsequently be stored on the service storage array, and catalogued in a chunk index. The chunk index may represent a data structure (e.g., a data table), stored on the service storage array, for maintaining various information pertaining to one or more data file chunks. Information relating to each data file chunk may be indexed by way of a chunk index entry, which may store at least the following information respective to a given data file chunk: (a) a chunk fingerprint (or hash) uniquely identifying the given data file chunk; and (b) a storage location or address on the service storage array wherein the given data file chunk may be stored. Each chunk index entry may specify additional or alternative information pertinent to a given data file chunk without departing from the scope of the invention.

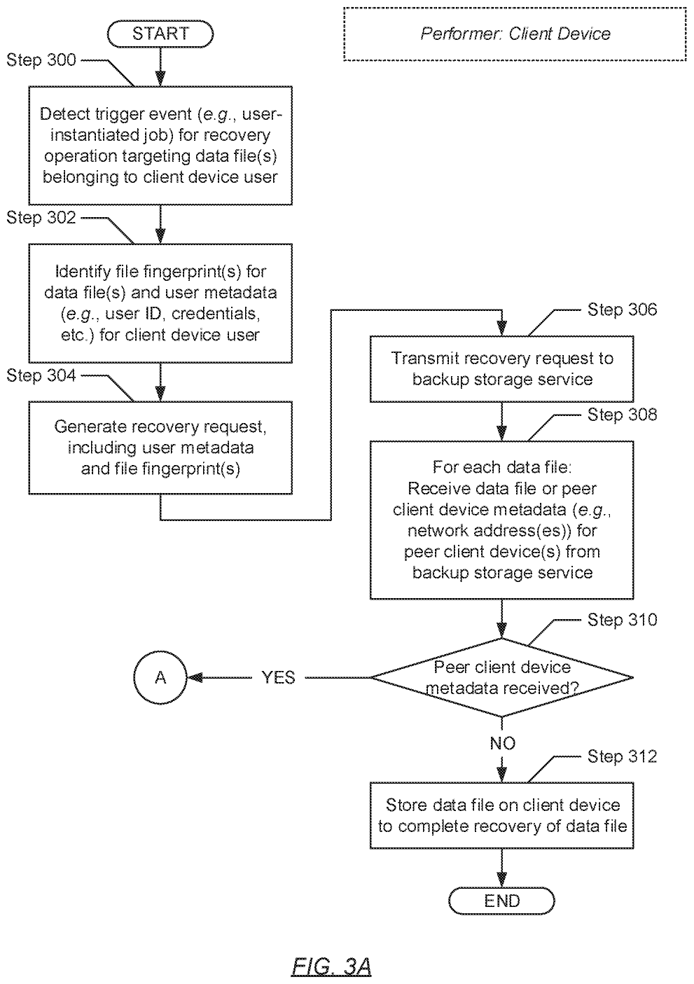

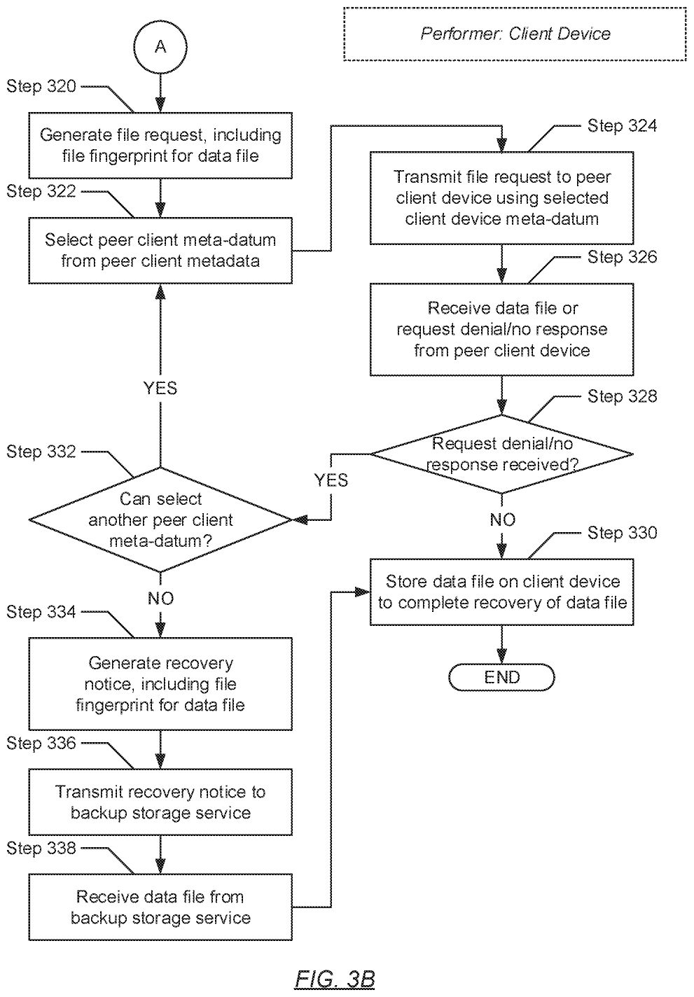

FIGS. 3A and 3B show flowcharts describing a method for recovering data files in accordance with one or more embodiments of the invention. The various steps outlined below may be performed by any client device (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, a trigger event is detected. In one embodiment of the invention, the trigger event may pertain to a recovery operation targeting one or more data files that had once resided on the client device. The trigger event may, for example, take the form of a user-instantiated job following the loss/deletion or corruption of the targeted data file(s).

In Step 302, one or more file fingerprints and user metadata are identified. In one embodiment of the invention, the identified file fingerprint(s) may reference the data file(s) (targeted by the recovery operation triggered in Step 300). Further, the user metadata may encompass at least the following information pertaining to a client device user of the client device: (a) a user identifier (ID) associated with the client device user; and (b) authentication credentials (e.g., passwords, passphrases, pin numbers, biometric data, etc.) linked to the user ID.

In Step 304, a recovery request is generated. In one embodiment of the invention, the recovery request may include the user metadata and the file fingerprint(s) (identified in Step 302). Subsequently, in Step 306, the recovery request (generated in Step 304) is transmitted to a backup storage service (see e.g., FIG. 1A).

In Step 308, for each data file (targeted by the recovery operation triggered in Step 300), a copy of the data file or peer client device metadata is received from the backup storage service (in response to the recovery request submitted thereto in Step 306). With respect to the latter, in one embodiment of the invention, the peer client device metadata may include, but is not limited to, information necessary to direct data file requests to one or more peer client devices, such as the network address(es) and request-accepting port number(s) associated with the peer client device(s). A peer client device may represent another client device, other than the client device performing the steps outlined in FIGS. 3A and 3B, which may maintain a local copy of the recovery-targeted data file.

In Step 310, a determination is made, for each recovery-targeted data file, as to whether peer client device metadata (described above) had been received (in Step 308). In one embodiment of the invention, if it is determined that peer client device metadata had been received for the data file, then the process proceeds to Step 320 (see e.g., FIG. 3B). On the other hand, in another embodiment of the invention, if it is alternatively determined that a copy of the data file had been received for the data file, then the process alternatively proceeds to Step 312.

In Step 312, upon determining (in Step 310), for a given recovery-targeted data file, that a copy of the given data file had been received (in Step 308), the received data file copy is stored into the client storage array (see e.g., FIG. 1B). Further, in one embodiment of the invention, storage of the received data file copy therein may mark the completion of the recovery operation at least with respect to the given data file.

Turning to FIG. 3B, in Step 320, upon alternatively determining (in Step 310), for a given recovery-targeted data file, that peer client device metadata had been received (in Step 308), a file request is generated. In one embodiment of the invention, the file request may include the file fingerprint (identified in Step 302) for the given data file.

In Step 322, per a listed order of the received information, peer client device metadata for a peer client device is selected. In one embodiment of the invention, the listed order may refer to an order in which metadata for the peer client device(s) had been listed or received from the backup storage service (in Step 308) in response to the recovery request (transmitted thereto in Step 306).

In Step 324, the file request (generated in Step 320) is transmitted to a peer client device. Specifically, in one embodiment of the invention, the peer client device may be associated with the peer client device metadata (selected in Step 322). Thereafter, in Step 326, either a copy of the given recovery-targeted data file or a request denial is received from the peer client device (to which the file request had been transmitted in Step 324). That is, in one embodiment of the invention, had there been no access restrictions applied to a local copy of the given data file maintained on the peer client device, a copy of the given data file may have been received in response to the transmitted file request. In another embodiment of the invention, had there been access restrictions imposed on a local copy of the given data file maintained on the peer client device, a denial of the file request transmitted thereto may have alternatively been received as a response. With respect to the latter, no response following the elapse of a specified time interval (or a timeout) may have instead been received in place of a request denial. Regardless, in either case, retrieval of a copy of the given data file via the peer client device had not been achieved.

In Step 328, a determination is made as to whether a request denial (or no response) had been received (in Step 326). In one embodiment of the invention, if it is determined that a request denial/no response had been received, then the process proceeds to Step 332. On the other hand, in another embodiment of the invention, if it is alternatively determined that a copy of the recovery-targeted data file had been received, then the process alternatively proceeds to Step 330.

In Step 330, upon determining (in Step 328) that a copy of a given recovery-targeted data file had been received (in Step 326), the received data file copy is stored into the client storage array (see e.g., FIG. 1B). Further, in one embodiment of the invention, storage of the received data file copy therein may mark the completion of the recovery operation at least with respect to the given data file.

In Step 332, upon alternatively determining (in Step 328) that a request denial (or no response) had been received (in Step 326), a determination is made as to whether the file request (generated in Step 320) may be directed to another peer client device. In one embodiment of the invention, if it is determined that peer client metadata for at least another peer client device had been received from the backup storage service (in Step 308), then the file request may be directed to another peer client device and, accordingly, the process proceeds to Step 322, where another peer client metadata is selected per the listed order. On the other hand, in another embodiment of the invention, if it is alternatively determined that the list of received peer client device metadata has been exhausted or no other peer client device metadata for at least another peer client device had been received from the backup storage service (in Step 308), then the file request may not be directed to another peer client device and, accordingly, the process alternatively proceeds to Step 334.

In Step 334, upon determining (in Step 332) that a request denial (or no response) had been received from any and all peer client devices to which the file request (generated in Step 320) had been directed, a recovery notice is generated. In one embodiment of the invention, the recovery notice may represent a message indicating that recovery of a given data file from one or more peer client devices has failed. Further, the recovery notice may include the file fingerprint (identified in Step 302) for the given data file.

In Step 336, the recovery notice (generated in Step 334) is transmitted to the backup storage service. Subsequently, in Step 338, in response to the recovery notice, a copy of the given data file is received from the backup storage service. Thereafter, the process proceeds to Step 330.

FIGS. 4A and 4B show flowcharts describing a method for recovering data files in accordance with one or more embodiments of the invention. The various steps outlined below may be performed by the backup storage service (see e.g., FIGS. 1A and 1C). Further, while the various steps in the flowchart are presented and described sequentially, one of ordinary skill will appreciate that some or all steps may be executed in different orders, may be combined or omitted, and some or all steps may be executed in parallel.

Turning to FIG. 4A, in Step 400, a recovery request is received from a client device (see e.g., FIG. 1A). In one embodiment of the invention, the recovery request may pertain to recovering one or more data files once residing on the client device. The recovery request, accordingly, may include user metadata associated with a client device user of the client device and to which the data file(s) belong; and one or file fingerprints (described above) for the data file(s). The user metadata may include, but is not limited to, a user identifier (ID) uniquely associated with the client device user, and authentication credentials (e.g., passwords, passphrases, pin numbers, biometric data, etc.) linked to the user ID.

In Step 402, a lookup is performed on a user index using the user ID (i.e., user metadata) (received in Step 400) to identify an existing user index entry mapped to the client device user. In one embodiment of the invention, the user index may represent a data structure (e.g., a data table), stored on the service storage array, for maintaining various information pertaining to one or more client device users. Information relating to each client device user may be indexed by way of a user index entry, which may store at least the following information respective to a given client device user: (a) a user ID uniquely identifying the given client device user; (b) authentication credentials (e.g., a password, a passphrase, a pin number, biometric data, etc.) linked to the user ID; (c) a file directory maintaining the file fingerprint for each data file pertaining to the given client device user, alongside the storage tier (described below) with which the data file may be associated; and (d) client device metadata describing the client device being operated by the given client device user. The client device metadata may include, but is not limited to, a device name assigned to the client device, a network address (e.g., an Internet Protocol (IP) address) assigned to the client device, a port number of the client device through which data file requests may be made, etc. Each user index entry may specify additional or alternative information pertinent to a given client device user without departing from the scope of the invention.

In Step 404, a lookup is performed on the above-mentioned file directory specified in the user index entry (identified in Step 402). In one embodiment of the invention, the lookup may utilize the file fingerprint(s) (received in Step 400) and may result in obtaining a storage tier (described above) mapped to each of the file fingerprint(s).

In Step 406, a lookup is performed on a file index using the file fingerprint(s) (received in Step 400). In one embodiment of the invention, the file index may represent a data structure (e.g., a data table), stored on the service storage array, for maintaining various information pertaining to one or more data files. Information relating to each data file may be indexed by way of a file index entry, which may store at least the following information respective to a given data file: (a) a file fingerprint (or hash) used to uniquely identify the content contained in the given data file; (b) a file recipe representative of a sequence of chunk fingerprints associated with (or directed to) unique data chunks identified throughout the undeduplicated data of the given data file; (c) a user list including one or more user IDs for one or more client device users, where the client device user(s) each maintain a local copy of the given data file on their respective client device(s); and (d) data file metadata describing the given data file such as, for example, a file size (in bytes) reflecting the storage size of the given data file. Each file index entry may specify additional or alternative information pertinent to a given data file without departing from the scope of the invention.

In one embodiment of the invention, the lookup (performed in Step 406) may result in the identification of a file index entry for each file fingerprint used to conduct the lookup. An identified file index entry may specify a stored file fingerprint matching a file fingerprint (received in Step 400). Thereafter, in Step 408, from each file index entry (identified in Step 406), a file size (i.e., data file metadata) indicating the storage size (in bytes), pertaining to a given data file, is obtained.

In Step 410, a determination is made, for each given data file sought to be recovered by the client device, as to whether the storage tier (obtained in Step 404) and the file size (obtained in Step 408), for the given data file, satisfy file transfer criteria. The file transfer criteria may entail prescribed conditions through which downloading (or transmission) of data from the backup storage service to the client device is practical and/or inexpensive. Furthermore, satisfying the file transfer criteria may be achieved by: (a) the storage tier meeting a prescribed storage tier threshold (described below); and (b) the file size not exceeding a prescribed file size threshold (described below). Conversely, not satisfying the file transfer criteria may be reflected by: (a) the storage tier not meeting the prescribed storage tier threshold; or (b) the file size exceeding the prescribed file size threshold. Accordingly, in one embodiment of the invention, if it is determined that the file transfer criteria has been met, then the process proceeds to Step 412. On the other hand, in another embodiment of the invention, if it is alternatively determined that the file transfer criteria has not been met, then the process alternatively proceeds to Step 420 (see e.g., FIG. 4B).

In Step 412, upon determining (in Step 410) that file transfer criteria (described above) has been met for a given data file sought to be recovered by the client device, a file recipe for the given data file is obtained. In one embodiment of the invention, the file recipe (described above) may be obtained from the file index entry (identified in Step 406) for the given data file.

In Step 414, the given data file is reconstructed based on the file recipe (obtained in Step 412). Specifically, in one embodiment of the invention, a reversal of the data deduplication process, which had led to the generation of the file recipe, may be performed. The reconstructed data file may subsequently reflect content in undeduplicated form. Thereafter, in Step 416, the given data file (reconstructed in Step 414) is transmitted to the client device in response to the recovery request (received in Step 400).

Turning to FIG. 4B, in Step 420, a user list, for the given data file sought to be recovered by the client device, is obtained. Specifically, in one embodiment of the invention, the user list may be obtained from the file index entry (identified in Step 406) for the given data file. Further, the user list may include one or more peer client device user IDs for peer client device user(s) that operate peer client device(s) on which a local copy of the given data file may be maintained.

In Step 424, peer client device metadata for each of the peer client device user ID(s) (obtained in Step 420) is obtained. In one embodiment of the invention, obtaining of the peer client device metadata, relating to a given peer client device user ID, may entail: performing a lookup on the user index using the given peer client device user ID to identify a user index entry; and extracting client device metadata specified in the identified user index entry. The extracted client device metadata may include, but is not limited to, a network address (e.g., an Internet Protocol (IP) address) assigned to the client device, and a port number of the client device through which data file requests may be made. Thereafter, in Step 426, the collective peer client device metadata (obtained in Step 424), respective to the peer client device user ID(s) (obtained in Step 420), is transmitted to the client device (from which the recovery request had been received in Step 400).

In one embodiment of the invention, following the transmission of the collective peer client device metadata (in Step 426), the process ends. In such an embodiment, the client device (to which the transmission had been directed) may have succeeded in obtaining a copy of a given data file from a peer client device, metadata of which may have been included in the collective peer client device metadata. In another embodiment of the invention, following the transmission of the collective peer client device metadata (in Step 426), the process alternatively proceeds to Step 428. In such an embodiment, the client device (to which the transmission had been directed) may have failed in obtaining a copy of a given data file from any peer client device associated with metadata of which may have been included in the collective peer client device metadata.

In Step 428, a recovery notice is received from the client device. In one embodiment of the invention, the recovery notice may represent a message indicative of the failure of the client device to obtain a copy of one or more data files from a peer client device. Accordingly, the recovery notice may include one or more file fingerprints pertinent to the unsuccessfully retrieved data file(s).

In Step 430, a lookup is performed on the file index (described above) using the file fingerprint(s) (received in Step 428) to identify one or more file index entries, respectively. An identified file index entry may specify a stored file fingerprint that matches one of the received file fingerprints. In Step 432, from each file index entry (identified in Step 430), a file recipe (described above) for a given data file respective to the identified file index entry is obtained therefrom.

In Step 434, one or more data files is/are reconstructed based on their respective file recipe (obtained in Step 432). Specifically, in one embodiment of the invention, a reversal of the data deduplication process, which had led to the generation of the file recipe, may be performed. The reconstructed data file(s) may each subsequently reflect content in undeduplicated form. Thereafter, in Step 436, the given data file(s) (reconstructed in Step 434) is/are transmitted to the client device in response to the recovery notice (received in Step 428).

FIG. 5 shows an exemplary computing system in accordance with one or more embodiments of the invention. The computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a central processing unit (CPU) and/or a graphics processing unit (GPU). The computing system (500) may also include one or more input devices (510), such as a touchscreen, keyboard, mouse, microphone, touchpad, electronic pen, or any other type of input device. Further, the communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

In one embodiment of the invention, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for data file recovery, comprising:
receiving, from a client device, a recovery request comprising a first file fingerprint for a first data file;
identifying a first storage tier and a first file size using the first file fingerprint;
making a first determination, based on the first storage tier and the first file size, that the first data file fails to satisfy file transfer criteria;
obtaining, based on the first determination, a user list comprising a first peer user identifier (ID), wherein the user list is associated with the first data file;
identifying first peer client device metadata using the first peer user ID; and
transmitting, in response to the recovery request, the first peer client device metadata to the client device.

2. The method of claim 1, wherein the first data file failing to satisfy the file transfer criteria, comprises:
the first storage tier meeting a storage tier threshold; and
the first file size not exceeding a file size threshold.

3. The method of claim 1, further comprising:
receiving, from the client device, a recovery notice comprising the first file fingerprint;
obtaining, based on receiving the recovery notice, a file recipe for the first data file using the first file fingerprint;
reconstructing the first data file based on the file recipe; and
transmitting, in response to the recovery notice, the first data file to the client device.

4. The method of claim 1, wherein the user list further comprises a second peer user ID, wherein the method further comprises:
identifying second peer client device metadata using the second peer user ID; and
transmitting, further in response to the recovery request, the second peer client device metadata to the client device.

5. The method of claim 1, wherein the recovery request further comprises a second file fingerprint for a second data file, wherein the method further comprises:
identifying a second storage tier and a second file size using the second file fingerprint;
making a second determination, based on the second storage tier and the second file size that the second data file satisfies the file transfer criteria;
obtaining, based on the second determination, a file recipe for the second data file using the second file fingerprint;
reconstructing the second data file based on the file recipe; and
transmitting, further in response to the recovery request, the second data file to the client device.

6. The method of claim 5, wherein the second data file satisfying the file transfer criteria, comprises one selected from a group consisting of:
the second storage tier not meeting a storage tier threshold; and
the second file size exceeding a file size threshold.

7. The method of claim 5, wherein the file recipe comprises an ordered sequence of chunk fingerprints.

8. The method of claim 1, wherein the recovery request further comprises a user ID for a client device user of the client device, wherein the first storage tier is further identified using the user ID.

9. The method of claim 1, wherein the first peer client device metadata comprises a network address associated with a peer client device.

10. A method for data file recovery, comprising:
detecting a trigger event for a recovery operation targeting a first data file;
identifying a first file fingerprint for the first data file;
issuing, to a backup storage service, a recovery request comprising the first file fingerprint; and
receiving, in response to the recovery request, first peer client device metadata from the backup storage service.

11. The method of claim 10, further comprising:
issuing, using the first peer client device metadata, a file request to a first peer client device, wherein the file request comprises the first file fingerprint;
receiving, in response to the file request, the first data file from the first peer client device; and
storing the first data file to compete a recovery of the first data file.

12. The method of claim 10, wherein second peer client device metadata is received from the backup storage service in response to the recovery request, wherein the method further comprises:
issuing, using the first peer client device metadata, a first file request to a first peer client device, wherein the first file request comprises the first file fingerprint;
receiving, in response to the first file request, one selected from a group consisting of no response and a request denial, from the first peer client device; and
issuing, based on receiving one selected from the group in response to the first file request, a second file request to a second peer client device using the second peer client device metadata, wherein the second request comprises the first file fingerprint.

13. The method of claim 12, further comprising:
receiving, in response to the second file request, one selected from the group consisting of the no response and the request denial, from the second peer client device;
issuing, based on receiving one selected from the group in response to the second file request, a recovery notice to the backup storage service, wherein the recovery notice comprises the first file fingerprint;
receiving, in response to the recovery notice, the first data file from the backup storage service; and
storing the first data file to complete a recovery of the first data file.

14. The method of claim 12, further comprising:
receiving, in response to the second file request, the first data file from the second peer client device; and
storing the first data file to complete a recovery of the first data file.

15. The method of claim 10, wherein the recovery operation further targets a second data file, wherein the recovery request further comprises a second file fingerprint for the second data file, wherein the method further comprises:
receiving, further in response to the recovery request, the second data file from the backup storage service; and
storing the second data file to complete a recovery of the second data file.

16. The method of claim 10, wherein the first peer client device metadata comprises a network address associated with a peer client device.

17. The method of claim 10, wherein the recovery request further comprises a user identifier (ID) for a client device user, wherein the first data file belongs to the client device user.

18. The method of claim 17, wherein the trigger event is initiated by the client device user.

19. A system, comprising:
a plurality of client devices; and
a backup storage service operatively connected to the plurality of client devices, and comprising a computer processor programmed to:
receive, from a first client device of the plurality of client devices, a recovery request comprising a file fingerprint for a data file;
identify a storage tier and a file size using the file fingerprint;
make a determination, based on the storage tier and the file size, that the data file fails to satisfy file transfer criteria;
obtain, based on the determination, a user list comprising a peer user identifier (ID), wherein the user list is associated with the data file;
identify, using the peer user ID, peer client device metadata for a second client device of the plurality of client devices; and
transmit, in response to the recovery request, the peer client device metadata to the first client device.

20. The system of claim 19, wherein the backup storage service resides in a cloud computing environment.
